(19) United States
(12) Patent Application Publication
(10) Pub. No.: US 2013/0076510 A1
(43) Pub. Date: Mar. 28, 2013

(54) Broadband Alarm Reporting Using a Local Wireless Network

(71) Applicants: Christopher Lloyd Bear, Marietta, GA (US); Shawn Patrick Welsh, Marietta, GA (US)

(72) Inventors: Christopher Lloyd Bear, Marietta, GA (US); Shawn Patrick Welsh, Marietta, GA (US)

(73) Assignee: TELULAR CORPORATION, Chicago, IL (US)

(21) Appl. No.: 13/245,163

(22) Filed: Sep. 26, 2011

(51) Int. Cl. G08B 1/08

(52) U.S. Cl. 340/539.16

(57) ABSTRACT

In one aspect of the present invention there is provided a system that establishes a local wireless network between a bridge device and an alarm communicator to send event signals over the internet.

### FIELD OF THE INVENTION

The present invention relates generally to the field of security systems, and in particular to a system and method for reporting alarm event with broadband signals.

### BACKGROUND OF THE INVENTION

In residential and commercial alarm systems typically report events (including alarms) use a land-line phone connection to the central station. In traditional installations, the event data is sent through a combination of tones and data over the phone line to a DACR (digital alarm communication receiver) located at the central station. Recently, alarm panels have begun to support reporting of alarms via a broadband data interface, whereby the alarm panel uses a broadband connection (typically Ethernet) to report alarms to the central station via the premises data network. This method of alarm reporting has become particularly prevalent in commercial applications, where Ethernet connectivity is often available (or is easily made available) at the alarm panel location.

Residential installations, however, have been slow to adopt broadband as an alarm reporting medium. One of the significant factors impeding the adoption of broadband alarm reporting in the residential market has been the lack of Ethernet connectivity at or near the alarm panel. For obvious reasons, residential alarm panels are typically installed in relatively obscure locations, such as basement storage rooms or bedroom closets. Broadband gateways, on the other hand, are typically located in home offices or bedrooms where computer equipment is to be found. The approach described in this document utilizes a local wireless link to establish a supervised path between an alarm communicator connected to the alarm panel, and a bridge device connected to an Ethernet gateway or router. In this way, a reliable alarm reporting path is maintained between the alarm panel and the central monitoring station, without the need for a wired communication interface to the alarm panel.

### SUMMARY OF THE INVENTION

It is therefore an aspect of the present invention to improve upon the prior art by providing a system and/or method that provides in one embodiment a method for communicating an alarm event from an alarm panel to an alarm communication center. The method as outlined by this embodiment may include the following steps: (a) establishing a connection between an alarm reporting apparatus to a broadband bridge device; (b) receiving an event data notification signal from the alarm reporting apparatus, the event data notification containing information on the alarm event; (c) translating the event data notification signal to a wireless event data format signal; and (d) transmitting the wireless event data format signal to the broadband bridge device for sending to an alarm communication center. The method embodiment may take further steps to transmit the wireless event data format signal to the broadband bridge device with a prior step of establishing a local wireless connection to the broadband bridge device whereby the transmission of the wireless event data format signal to the broadband bridge device is a local wireless transmission.

In another embodiment of the present invention, there is provided a system for communicating an alarm event from an alarm panel to an alarm communication center. The system includes an alarm communicator having a first communication interface to an alarm panel; a second communication interface to a broadband bridge device; conversion software configured to translate an event data notification signal received over the first communication interface from the alarm reporting apparatus to a wireless event data format signal, wherein the event data notification contains information on an alarm event; and transmission software configured to transmit the wireless event data format signal over the second communication interface to the broadband bridge device for further sending to an alarm communication center.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

A fuller understanding of the foregoing may be had by reference to the accompanying drawings, wherein:

FIG. 1 is a schematic of a system in accordance with an embodiment of the present invention that allows for broadband alarm reporting;

FIG. 2 is a schematic of the alarm communicator in communication with the bridge device in accordance to one embodiment of the present invention;

FIG. 3 is a method of the alarm communicator as it receives events and sends events to the bridge device in accordance with one embodiment of the present invention; and

FIG. 4 is a method of the broadband bridge device as it receives events from the alarm communicator.

### DETAILED DESCRIPTION OF THE EMBODIMENTS

While the invention is susceptible to embodiments in many different forms, there are shown in the drawings and will described herein, in detail, the preferred embodiments of the present invention. It should be understood, however, that the present disclosure is to be considered an exemplification of the principles of the invention and is not intended to limit the spirit or scope of the invention and the embodiments illustrated.

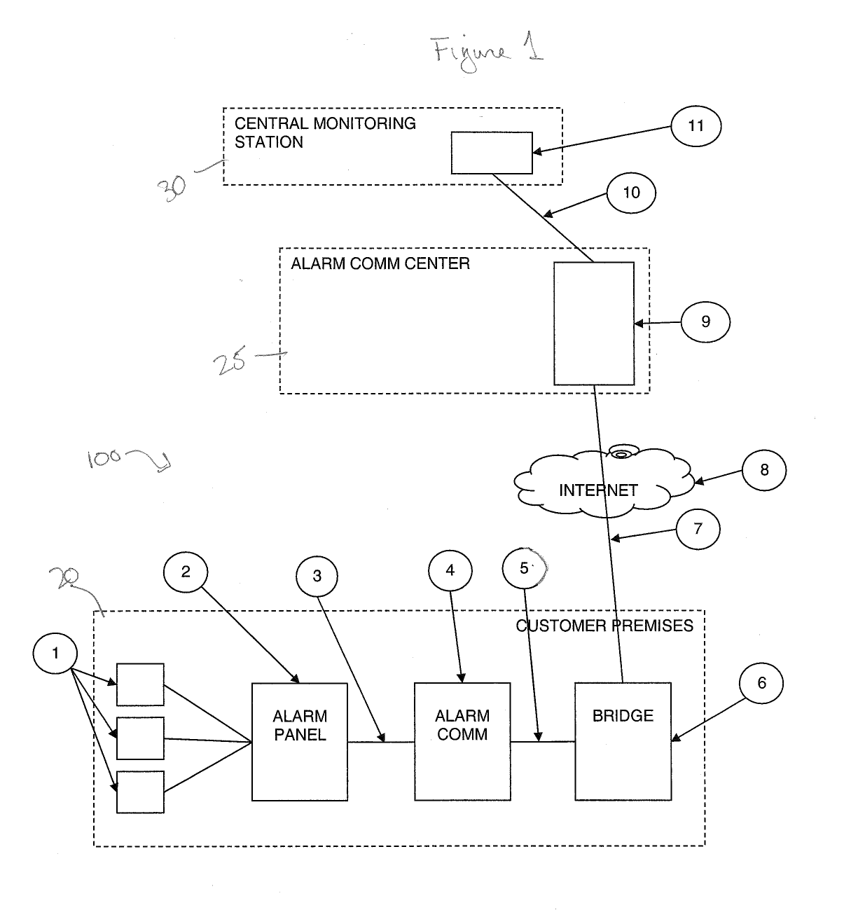

FIG. 1 illustrates an overview of a system 100 in accordance with an embodiment of the present invention that allows an alarm panel 2 to send event data to and receive commands from an alarm communication center 25 by broadband signals. The system 100 includes a customer premises 20, an alarm communication center 25 and a central monitoring station 30. The customer premises 20 includes one or more security sensors 1. The sensors 1, detect intrusion, movement, fire, and other events and will send notifications to the alarm panel. Sensors may be connected to the alarm panel through either wired or wireless connections.

The alarm panel 2 includes an alarm communicator reporting interface 3 used to report events to the alarm communicator 4. For alarm panels providing listen-in or 2-way voice capability, this is a dial capture (telephone) connection or it may be a data connection, e.g. Ethernet. It reports events in a particular format, e.g. Contact ID, which contains information about the event, as well as where and when it occurred. The alarm communicator 4 provides a communication path between the alarm panel 2 and the alarm communication center 25 for reporting events.

The alarm communicator 4 connects to the alarm communication center 25 through either a wireless signal transmitted over a cellular network to the alarm communication center and/or through a wireless interface 5 to a bridge device 6. The interface 5 provides the alarm reporting path from the alarm communicator 4 to the bridge device 6. It may utilize one or more local wireless technologies including but not limited to ZigBee, ZWave, WiFi, or a proprietary wireless format. In addition to reporting alarm signals, the interface 5 may also be used for configuration of the alarm communicator and/or bridge, as well as supervision of the devices and their interfaces. Interface 5 is supervised in both directions, so that the Alarm Communicator 4 and the bridge 6 detect a loss of communication on interface 5. A loss of communication on this interface may be indicated by either device an audible annunciation, a visual indicator, or some other appropriate means.

The bridge device 6 is capable of format translation of the wireless alarm signals received from the alarm communicator 4 into broadband signals suitable for transmission over the Internet 8. Usually, the transmission would include an Ethernet connection. The bridge device 6 is also responsible for supervising both links (local wireless and Internet connection).

A long-range data interface 7 connects the bridge device 6 to the alarm communication processing subsystem 9. The connection would be an IP connection and may include several public and private routing devices. A typical residential configuration would have the bridge device connected to a residential router via Ethernet, which would in turn be connected to a cable modem, which would provide Internet connectivity through a cable provider. As noted above, the internet 8 is used to transport alarm signals between the bridge device and the alarm communication center. Although this is typically a publically routed IP connection for residential applications, the connection to the alarm communication center 25 may be transported over a virtual private network.

The alarm communication processing subsystem 9 receives events from the alarm communicator 4 through the bridge device 6, and the alarm panel to which it is connected. When an event report is received from the alarm communicator, it converts the event report to a standard alarm signal, contacts the central station and reports the alarm in the original format that was used by the alarm panel to report the alarm to the alarm communicator.

The alarm communication processing subsystem 8 uses an interface 10 to connect to the central monitoring station 30. This interface 10 is an alarm communication center/alarm receiver interface 10, which is a circuit-switched connection that delivers tones and data containing event information. The connection is usually made through the Public Switched Telephone Network (PSTN), although it may also be made over private connections. There may also be private telephony equipment, such as a PBX, used at the central monitoring station to route the connection to the alarm receiver 11 as appropriate.

The alarm receiver 11 collects event reports that originated from the alarm panel 3, which is connected through the alarm communicator 4, bridge device 6, and the alarm communication center 25. The events are typically processed by central monitoring station 30, and are routed to attendants as appropriate.

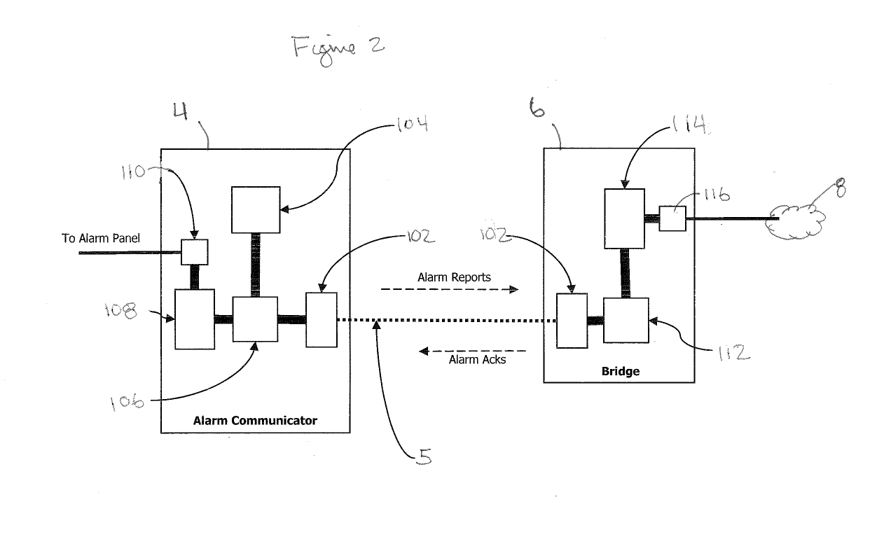

FIG. 2 shows an alarm communicator 4 in connection with the bridge device 6. As illustrated in this one embodiment of the present invention, the connection between the two can be a local wireless link 5. Through local wireless modules 102 the alarm communicator 4 and the bridge device 6 will establish the wireless link 5, at which point the alarm communicator 4 can send alarm reports to the bridge device 6 and bridge device 6 can send alarm acknowledgements to the alarm communicator 4.

The alarm communicator 4 may include a cellular module 104, an alarm communicator controller 106, a telephony circuit 108 and a jack port 110. The jack port 110 permits an interface to the alarm panel 2. The cellular module 104, if present, provides a communication path with the cellular network for provisioning and alarm reporting, should the bridge interface 5 or the Internet interface 7 be unavailable. The communicator controller provides the intelligence for the provisioning, supervision and alarm reporting functions of the alarm communicator. The telephony circuit provides the electrical signals necessary for communicating with the alarm panel through a telephony interface, including, but not limited to, dial tone, ringback tone, and on and off hook indication. The bridge device 6 includes a bridge controller 112 and an Ethernet circuit 114, which permits Ethernet connectivity. The bridge controller 112 is provided software configured to provide the format translation of the wireless alarm signals received from the alarm communicator 4 into the broadband signals suitable for transmission. Transmission of the broadband signals occurs at the router 116 over the Internet 8.

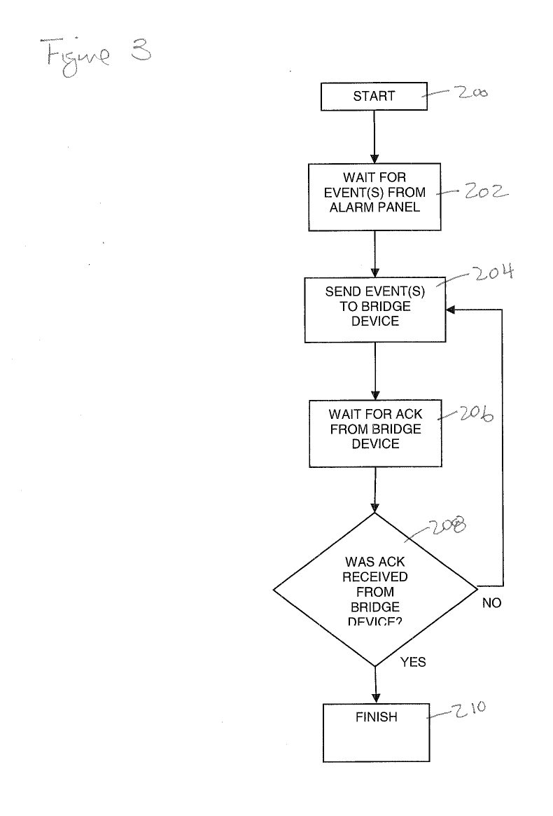

Referring now to FIG. 3, there is a method in accordance with an aspect of the present invention. The method starts, box 200, with the alarm communicator 4 waiting for event(s) from the alarm panel, box 202. The event(s) once occurred are sent to the bridge device 6, box 204. The alarm communicator will wait for an alarm acknowledgement back from the bridge device 6, box 206. As noted below, the alarm acknowledgement is received from the alarm communication center when the alarm communication center receives the alarm event from the bridge device. If an acknowledgement has not been received, box 208, the alarm communicator 4 will continue to re-send event(s) to the bridge device. Once the acknowledgement is received the method will end, box 210.

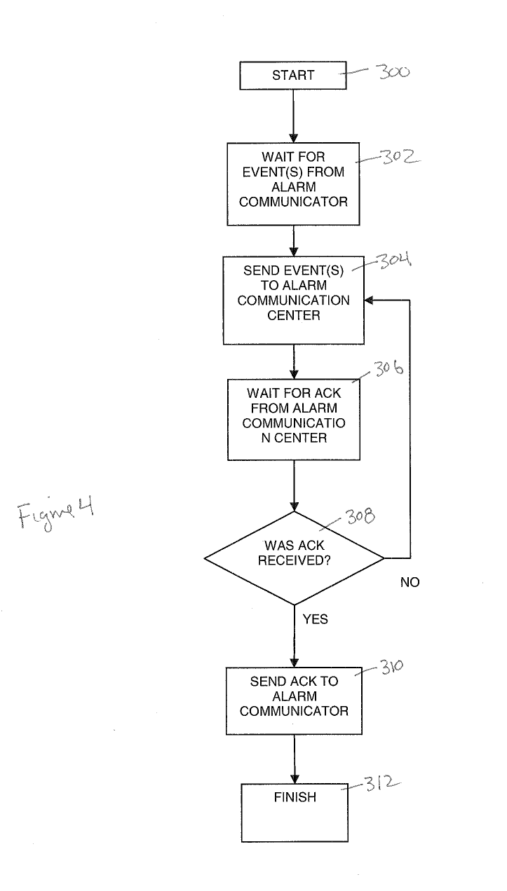

Referring now to FIG. 4, there is a method in accordance with an aspect of the present invention. The method starts, box 300, with the bridge device 6 waiting for event(s) from the alarm communicator, box 302. The bridge device 6 will then send the event(s) to the alarm communication center, box 304. As noted above, this is accomplished by first converting the alarm event(s) into broadband signals and then transmitting the broadband signals to the alarm communication center. The bridge device 6 will then wait for an alarm acknowledgement from the alarm communication center, box 306. The alarm acknowledgement will be received in the form of broadband signals, which the bridge device 6 will convert to a format compatible with the interface 5 between the bridge and the alarm communicator. The bridge device 6 will check for an alarm acknowledgement, box 308 and will re-send the event(s) if it has not received the acknowledgement (return to box 304). Once the alarm acknowledgement has been received the bridge device 6 will send the alarm acknowledgement to the alarm communicator 4, box 310, and the method will end, box 312.

In addition to the above noted systems and methods, variation on the aforementioned include having multiple alarm paths. While the above typically described a single alarm communication path through the bridge device, other implementations are possible, including a cellular backup communication path from the cellular module in the alarm communicator. Alternatively, the connectivity between the alarm panel and the alarm communicator is described in as a dial-capture using a telephony connection, however, alternative implementations may include an Ethernet or other standard communication mechanism.

In addition, alternative local transport technologies may be included. As mentioned previously, the transport mechanism for the communication path between the alarm communicator and the bridge device may be any standard or proprietary wireless technology, for example ZigBee, Z-Wave, or WiFi. In addition, it would also be possible to utilize non-wireless technologies for this communication path, such as BPL (Broadband Over Powerline).

Various supervised wireless path technologies may also be employed. As part of the above method, the communication path between the alarm communicator and the bridge device is periodically monitored. In addition, the path between the bridge device and the alarm communication center is also periodically monitored, and the alarm communicator notified when the path is interrupted. The alarm communicator may signal the alarm panel via relays that the communication path is not available.

In addition to providing a wireless path for the signals from the alarm communicator, the bridge device may also provide wireless connectivity to other compatible local devices, such as thermostats, door locks, etc. Connectivity to these devices would enable additional residential management services.

As applied to the present invention, there may be provided in an embodiment derived therefrom, a method for communicating an alarm event from an alarm panel to an alarm communication center. The method as outlined by this embodiment may include the following steps: (a) establishing a connection between an alarm reporting apparatus to a broadband bridge device; (b) receiving an event data notification signal from the alarm reporting apparatus, the event data notification containing information on the alarm event; (c) translating the event data notification signal to a wireless event data format signal; and (d) transmitting the wireless event data format signal to the broadband bridge device for sending to an alarm communication center. The method embodiment may take further steps to transmit the wireless event data format signal to the broadband bridge device with a prior step of establishing a local wireless connection to the broadband bridge device whereby the transmission of the wireless event data format signal to the broadband bridge device is a local wireless transmission.

In other aspects of the method embodiment, further steps may include receiving an acknowledgment signal from the broadband bridge device acknowledging the transmission of the wireless event data format signal to the alarm communication center; transmitting the wireless event data format signal to the alarm communication center over a cellular network and/or continuously receiving a broadband connectivity notification from the broadband bridge device, and providing a visual and/or audible indication when the broadband connectivity notification indicates a loss of broadband connectivity.

It being yet further defined such that the transmission over a cellular network is concurrently with the transmission of the wireless event data format signal to the broadband bridge device.

In another embodiment of the present invention, there is provided a system for communicating an alarm event from an alarm panel to an alarm communication center. The system includes an alarm communicator having a first communication interface to an alarm panel; a second communication interface to a broadband bridge device; conversion software configured to translate an event data notification signal received over the first communication interface from the alarm reporting apparatus to a wireless event data format signal, wherein the event data notification contains information on an alarm event; and transmission software configured to transmit the wireless event data format signal over the second communication interface to the broadband bridge device for further sending to an alarm communication center.

In various embodiments of the system, the second communication interface may be a local wireless connection between the broadband bridge device and the alarm communicator, and/or the alarm communicator may include an acknowledgement software configured to receive an acknowledgment signal from the broadband bridge device acknowledging the transmission of the wireless event data format signal to the alarm communication center.

The alarm communicator may also include a third communication interface configured to transmit the wireless event data format signal to an alarm communication center over a cellular network. It may be a further aspect to have the transmission over the cellular network be concurrent with the transmission of the wireless event data format signal to the broadband bridge device; or the transmission over the cellular network be primary to the broadband bridge transmission or the transmission may be secondary to the broadband bridge transmission.

In addition, the alarm communicator may further include software connectivity notification software configured to continuously receive a broadband connectivity notification from the broadband bridge device, and the connectivity notification software further configured to activate a visual and/or audible indicator when the broadband connectivity notification indicates a loss of broadband connectivity.

From the foregoing and as mentioned above, it will be observed that numerous variations and modifications may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

We claim:

1. A method for communicating an alarm event from an alarm panel to an alarm communication center, the method comprising:
establishing a connection between an alarm reporting apparatus to a broadband bridge device;
receiving an event data notification signal from the alarm reporting apparatus, the event data notification containing information on the alarm event;
translating the event data notification signal to a wireless event data format signal; and
transmitting the wireless event data format signal to the broadband bridge device for sending to an alarm communication center.

2. The method of claim 1, wherein the step of transmitting the wireless event data format signal to the broadband bridge device includes a prior step of establishing a local wireless connection to the broadband bridge device whereby the transmission of the wireless event data format signal to the broadband bridge device is a local wireless transmission.

3. The method of claim 1 further comprising:
receiving an acknowledgment signal from the broadband bridge device acknowledging the transmission of the wireless event data format signal to the alarm communication center.

4. The method of claim 1 further comprising:
transmitting the wireless event data format signal to the alarm communication center over a cellular network.

5. The method of claim 4 wherein the transmission over a cellular network is concurrently with the transmission of the wireless event data format signal to the broadband bridge device.

6. The method of claim 1 further comprising:
continuously receiving a broadband connectivity notification from the broadband bridge device, and providing a visual and/or audible indication when the broadband connectivity notification indicates a loss of broadband connectivity.

7. A system for communicating an alarm event from an alarm panel to an alarm communication center, the system comprising:
an alarm communicator having:
a first communication interface to an alarm panel;
a second communication interface to a broadband bridge device;
conversion software configured to translate an event data notification signal received over the first communication interface from the alarm reporting apparatus to a wireless event data format signal, wherein the event data notification contains information on an alarm event; and
transmission software configured to transmit the wireless event data format signal over the second communication interface to the broadband bridge device for further sending to an alarm communication center.

8. The system of claim 7, wherein the second communication interface is a local wireless connection between the broadband bridge device and the alarm communicator.

9. The system of claim 7, wherein the alarm communicator includes acknowledgement software configured to receive an acknowledgment signal from the broadband bridge device acknowledging the transmission of the wireless event data format signal to the alarm communication center.

10. The system of claim 7, wherein the alarm communicator includes a third communication interface configured to transmit the wireless event data format signal to an alarm communication center over a cellular network.

11. The system of claim 10, wherein the transmission over a cellular network is concurrently with the transmission of the wireless event data format signal to the broadband bridge device.

12. The system of claim 7, wherein the alarm communicator further includes software connectivity notification software configured to continuously receive a broadband connectivity notification from the broadband bridge device, and the connectivity notification software further configured to activate a visual and/or audible indicator when the broadband connectivity notification indicates a loss of broadband connectivity.
